(19) United States
(12) Patent Application Publication
(10) Pub. No.: US 2003/0065756 A1
(43) Pub. Date: Apr. 3, 2003

(54) Method for providing services in a communication network corresponding service customer host

(75) Inventor: Francois Carrez, Thiais (FR)

Correspondence Address: SUGHRUE, MION, ZINN,, MACPEAK & SEAS, PLLC, 2100 Pennsylvania Avenue, N.W., Washington, DC, 20037-3213, US

(73) Assignee: ALCATEL

(21) Appl. No.: 10/253,799

(22) Filed: Sep. 25, 2002

(30) Foreign Application Priority Data
Oct. 3, 2001 (EP) 01 440 329.9

(51) Int. Cl. G06F 15/177; G06F 15/16

(52) U.S. Cl. 709/221; 709/203

(57) ABSTRACT

Method for providing services in a communication network comprising service customer hosts and service provider hosts, said service customer hosts comprising a client application adapted to perform a client/server communication, said method comprising the steps of:

Storing data structures, herein called service profiles, at a predefined communication network repository, a service profile comprising attributes and properties representing a service type;

Storing one or more instantiations of said service profile, herein called service description, on a predefined service description server, each service description describing a service belonging to one service type and comprising an identifier of a service provider host providing said service.

Downloading a service profile at a communication module of said service customer host;

Generating at said service customer host a request describing a service by using attributes and properties of said service profile and sending said request to said service description server;

Searching at said service description server service descriptions fulfilling said request and returning to said communication module an identifier of a service provider host providing a service fulfilling said request;

Forwarding to said client application said identifier of a service provider host over an interface between said communication module and said client application; and

Performing a client/server communication between said client application and said identified service provider host.

The invention is based on a priority application EP 01 440 329.9 which is hereby incorporated by reference.

### BACKGROUND OF THE INVENTION

The present invention relates to a method for providing services from service provider hosts to service customer hosts in a communication network and more particularly when service customer hosts try to discover available services in the communication network on their own initiative.

A service customer host should be understood, in the context of this invention, as a host of the communication network which want to be delivered a service from a service provider host present in the communication network. For this purpose, the service customer host can download a list of services and select a service from this list. Then, a transaction is launched between the service customer host and the service provider host. This transaction follows usually the client/server model.

An drawback is that service customer hosts are provided with a list of services which possibly contains a lot of services the user of service customer host is not interested in.

Moreover, especially in the context of on-purpose communication networks, such lists of services cannot easily be maintained since the topology and the composition of the on-purpose communication network is often modified. Then, instead of being provided with a list of service provider hosts, a service customer host should be able to apprehend its environment on his own.

A basic service discovery procedure (Service Discovery Protocol) has been implemented in the framework of Bluetooth technology. A such service discovery procedure has been enhanced with the introduction of the salutation protocols dedicated to enable potential service customer hosts to detect corresponding remote service provider hosts in their environment through requests toward a centralized service repository. A service customer host trying to obtain a predefined service generates a request for this service and includes it in the salutation protocol. If a service provider host reachable over the bluetooth interface supports this service, it answers to the request by returning its identifier. Then, a client/server transaction can be performed and the service provided at the service customer host.

Such a salutation protocol with service request as standardized for service customer hosts and service provider hosts compliant to the Bluetooth technologie is described in the document “Mapping salutation architecture APIs to Bluetooth Service Discovery Layer” Version 1.0 01 July 99 from the Bluetooth Special Interest Group.

This solution presents, nevertheless, the disadvantage that both service provider and service customer hosts should use the same language for qualifying the service e.g. same service name, same service parameters, same service options. This is relatively easy to ensure in the framework of Bluetooth capable devices which usually provide standardized and low-level services. In the context of on-purpose configuration network, more complex services should be provided. It is unlikely that any service customer host has a-priori knowledge of the relevant variables to parameterize the service. The result of a service request with parameters guessed at the service customer host and executed at a service provider host is highly unpredictable.

A particular object of the present invention is to provide a method for providing more efficiently services to service customer hosts especially in the context of on-purpose networks so that the service provider hosts can more accurately request services from service provider hosts.

Another object of the invention is to provide a service customer host structure to perform the method according to the present invention.

### SUMMARY OF THE INVENTION

These objects, and others that appear below, are achieved by a method for providing services in a communication network comprising service customer hosts and service provider hosts, said service customer hosts comprising a client application adapted to perform a client/server communication, wherein said method comprises the steps of:

Storing data structures, herein called service profiles, at a predefined communication network repository, a service profile comprising attributes and properties representing a service type;

Storing one or more instantiations of said service profile, herein called service description, on a predefined service description server, each service description describing a service belonging to one service type and comprising an identifier of a service provider host providing said service.

Downloading a service profile at a communication module of said service customer host;

Generating at said service customer host a request describing a service by using attributes and properties of said service profile and sending said request to said service description server;

Searching at said service description server service descriptions fulfilling said request and returning to said communication module an identifier of a service provider host providing a service fulfilling said request;

Forwarding to said client application said identifier of a service provider host over an interface between said communication module and said client application; and

Performing a client/server communication between said client application and said identified service provider host.

These objects are further achieved by a service customer host for use in a communication network also comprising service provider hosts, said service customer host comprising:

a client application adapted to perform a client/server communication to a service provider host;

a communication module for downloading a data structure, herein called service profile, from a predefined network communication repository;

means for composing a request thanks to attributes and properties of said service profile and sending said request to a predefined service description server;

an interface between said communication module and said client application for forwarding to said client application an identifier of a service provider host returned from said predefined description server.

According to the present invention, a service customer hosts can download a data structure herein called service profile corresponding to the type of service he wants to be provided with and compose a service request criterion made of constrained attributes values and properties of this service profile. He might also simply request for services complying to the service profile without any constraint. The service request is sent to a service description server which contains service description being instantiations of the service profile each comprising additionally an identifier of a service provider host supporting this service. Each server that instantiates such a “matching” service send back its identity and service name. Finally, a client/server communication can be established between the service customer host and the service provider host supporting the requested service, providing that the appropriate service client is present at the customer side.

The method according to the present invention presents the advantage to require few processing power at the service customer host when looking for a service since only the profile describing the service type is downloaded at the service customer host and not the whole available service descriptions. Only when the service has been chosen and the service provider host determined, the service customer host will have to access the service description to launch the client application with the appropriate parameters.

The method according to the present invention presents further the advantage to obtain a very detailed service description thanks to a hierarchic organization of the service profile with inheritance mechanism.

In a preferred embodiment of the present invention, the client application at the service customer host can be updated according to the service description returned by the service description server as result of said service request.

Further advantageous features of the invention are defined in the other dependent claims.

### BRIEF DESCRIPTION OF THE DRAWINGS

Other characteristics and advantages of the invention will appear on reading the following description of a preferred embodiment given by way of non-limiting illustrations, and from the accompanying drawings, in which:

FIG. 1 shows a communication network where the method according to the present invention can be used;

FIG. 2 represents an example of service profile and corresponding service description according to the present invention;

FIG. 3 illustrates an embodiment of the method for providing services in a communication network according to the present invention;

FIG. 4 illustrates a preferred embodiment of the method according to the present invention.

### DETAILED DESCRIPTION OF THE INVENTION

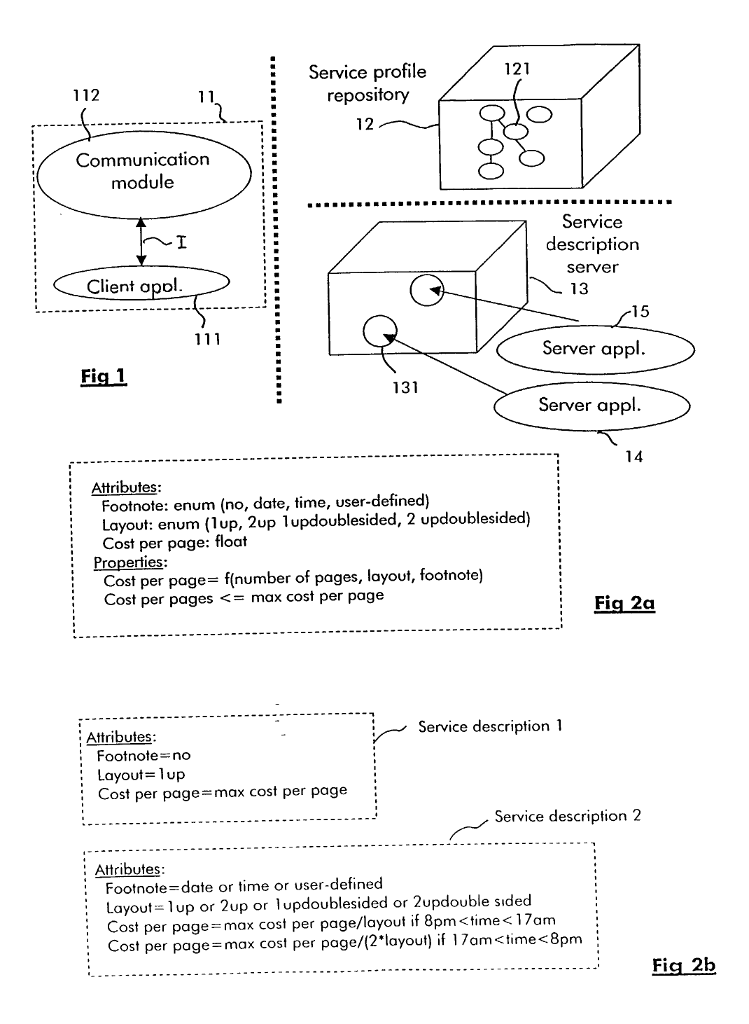

FIG. 1 shows a communication network where the method according to the present invention can be used. The communication network comprises a service customer host 11, a service profile repository 12, a service description server 13, and two service provider hosts 14, 15.

Service customer host 11 may be a terminal (i.e. a mobile phone or a personal digital assistant or even a note book) comprising at least a client application 111. For sake of simplicity, in the example detailed below a “print” client application will be illustrated. Other examples may be a client application for digital certificate authentication, for secured money transaction on the internet and so on. Service customer host 11 comprises further a communication module 112, and an interface I between client application 111 and communication module 112. For sake of simplicity, only one client application is represented in service customer host 11. It will be clear that a plurality of client applications can be supported at service customer host 11 for different services all having an interface to one single communication module 112. An internet browser may be used as communication module 112.Service provider hosts 14, 15 comprise server applications and can perform a client/server communication with an appropriate dedicated client application. In the example detailed below, service provider host 14 is a printer with basic print functionality while service provider host 15 is a printer with enhanced functionality.

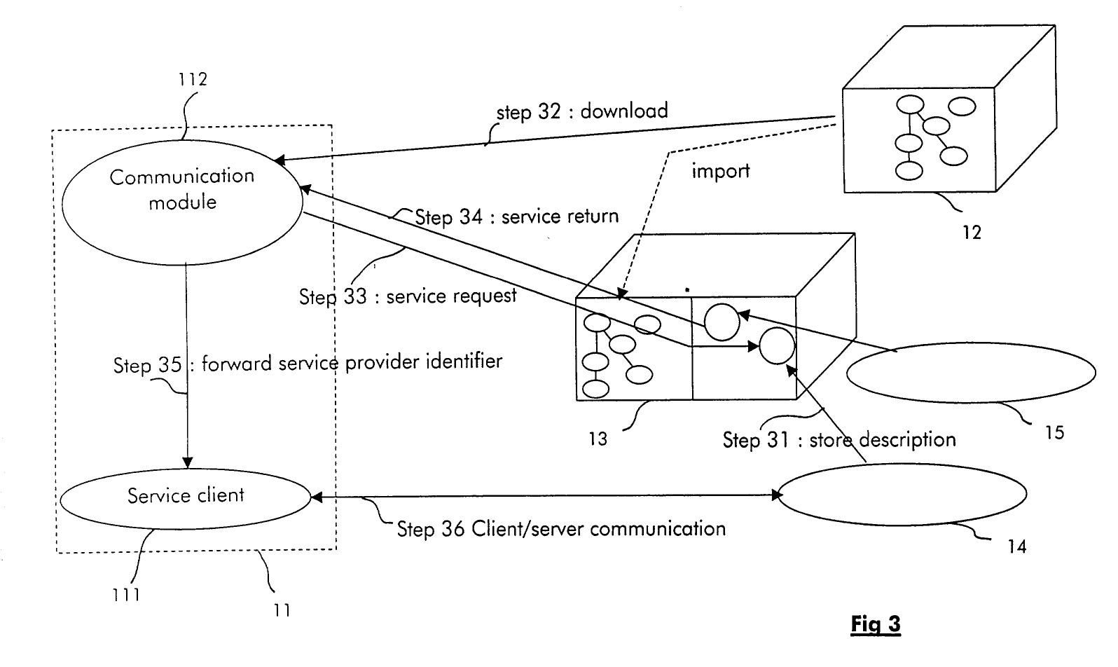

Service profile repository 12 stores service profiles of the different services available in the communication network. In the framework of the present invention a service profile is a data structure comprising attributes used for describing the service type and properties for describing the relations between different attributes. Such a service profile provides and abstract description for a service type. A language used for formalizing service profiles is preferably an object oriented language for example, but not restricted to, the use of the OKBC Open Knowledged Base Connectivity Model. Service profiles may be issued by an independent third party or agreed with in a community of users. FIG. 3a gives an example for a service profile related to the service “print”.

Service description server 13 comprises instantiations of service profiles called, in the framework of the present invention, service descriptions. Instantiations means that a value is allocated to the attributes of the service, this value should be compatible with the type of the attribute and the properties specified in the service profile.

The service descriptions should be generated by the different service host providers and comply to a service profile stored at the service profile repository 12. They should preferably be uploaded to the service description server 13. Service descriptions compliant to a service profile guaranty that service customer hosts, under the condition that they have the knowledge of the corresponding service profile, can better apprehend the functionality supported by a service provider host 14, 15 and make the best of it. A language used for formalizing service description is preferably compatible to an object oriented model. FIG. 3b gives an example for two service descriptions related to the service profile “print”.

It will be clear that the number of each components type (i.e. service customer hosts, service provider hosts, repository, service description server) composing the communication network can be chosen according to the topology of the communication network. Moreover, service profile repository 12 and service description server 13 may be co-located.

Preferably, the advantages of the method according to the present invention are the most useful in on-purpose communication networks. Such networks have no centralized control module and can be dynamically built and modified Terminals adapted to build such on-purpose networks also support network nodes functionality and can be both service provider hosts and service customer hosts. Such networks are also known under the name ad-hoc networks. It will, however, be clear for person skilled in the art that the method according to the present invention can also be applied to usual wireless communication networks or even to fixed communication networks.

FIG. 2a gives an example of a service profile related to the service “print”. The service profile comprises for sake of simplicity three attributes and two properties:

Attribute 1: footnote type enum (no, date, time, user-defined)

Attribute 2: layout type enumeration (1up, 2 up, 4up, 1updouble side, 2updouble sided, 4updouble sided)

Attribute 3: cost per page type float

Property 1: cost per page=f(number of pages, layout, footnote)

Property 2: cost per page<max cost per pages

According to this service profile the cost per page for this service can depend on the number of pages, on the layout requested and on the contend of the footnote. This service profile is stored at service profile repository 12.

FIG. 2b gives an example of two service description compliant with the service profile print.

Service description 1 describes the basic print service stored at service provider host 14.

Footnote=no

Layout=1 up

Cost per page=max cost per page. This basic service only allows one type of layout and has a fixed cost policy.

Service description 2 describes the enhanced print service stored at service provider host 15.

Footnote=date or time or user defined

Layout=(1up or 2 up or 1up double sided or 2 double sided)

Cost per pages=max cost per page/layout if time between 8 pm and 17 am

Cost per pages=max cost per page/(2*layout) else.

This service enables the printing of an additional footnote, a layout with 1up, 2up, 1up double sided or 2updouble sided layout. The cost policy depends on the time and on the chosen layout.

Both service description are stored at service description server 13.

FIG. 3 illustrates an embodiment of the method for providing services in a communication network according to the present invention.

The same network entities as in FIG. 1 are reused for illustrating the method according to the present invention.

The method for providing services according to the present invention comprises following steps:

Steps 31 should be performed once before performing the method according to the present invention.

Step 31 consists in registering a service description compliant with a corresponding service profile at the service description server 13 together with an identifier of the service provider host 14, 15 supporting this service.

Step 32 consists in downloading at communication module 112 a service profile from the service profile repository 12.

Step 33 consists in generating at communication module 112 a request by using attributes and properties of the downloaded service profile describing the service that is required at the service customer host. This service should be compatible with client application 111. A possible request compatible with the example used below may be:

Request (Print (footnote=date, layout=2updoublesided)).

Step 34 consists in searching at service description server 13 a service description fulfilling the request. For this purpose, the service descriptions are preferably stored in a searchable database. For easing the search in the database, the service profiles may be imported at service description server 13. This is especially useful if the service profiles and the service descriptions are organized in a hierarchic tree structure.

If one service description or more fulfil the request, the corresponding service provider host identifier is/are sent back to communication module 112. In this example the identifier of service provider host 14, 15 will be returned.

Step 35 consists in forwarding to client application 111 the identifier of the service provider host supporting the required service

Step 36 consists in performing a client/server communication between client application 111 and service provider host 14, 15. During this client/server communication the service is required by the client side and executed by the service provider host side. Usually, a Graphic User Interface (GUI) is launched by the client application for the user to selects the different values of the service profile attributes.

Alternatively as result of the request at step 35, the service can be automatically launched. Executable code means containing the service provider host identifier and the selected attributes of the request are forwarded from communication module 112, to client application 111 and executed there. This has the advantage not to request any further action of the end-user who has already specified enough the service he wishes.

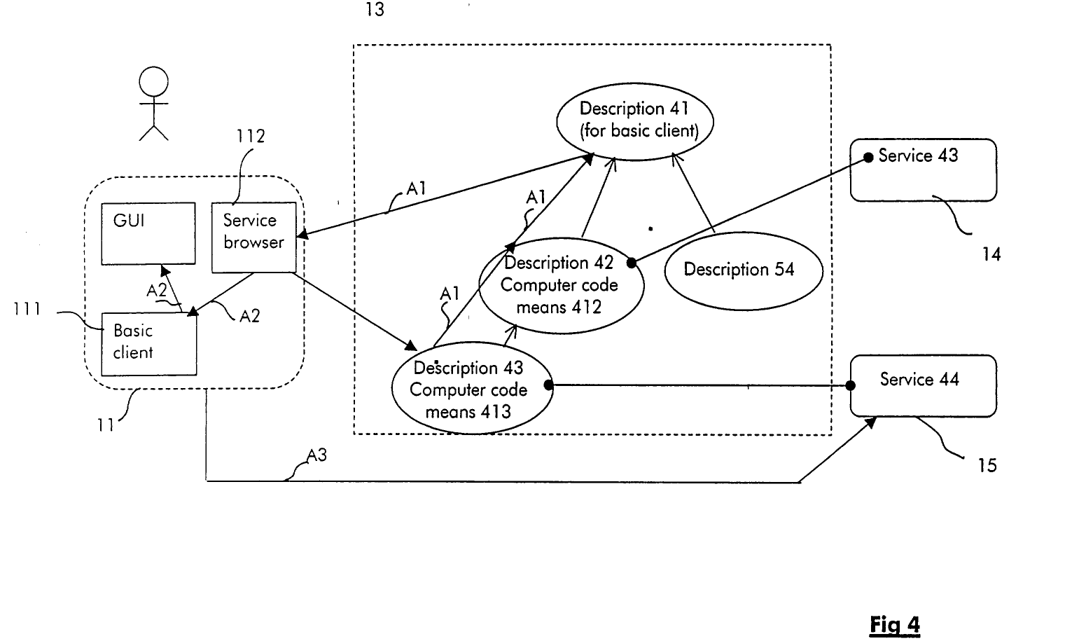

FIG. 4 illustrates a second embodiment of the method according to the present invention.

In this preferred embodiment of the present invention, the service profiles and the service descriptions are organized in a hierarchical tree structure with inheritance mechanism. This enables it to optimize the structure of the searchable database at the service description server 13.

In the present example, the hierarchical tree structure comprises four service descriptions 41, 42, 43, 44. Service description 41 is the root description and comprises all common attributes and properties, service description 42 and 44 inherit from service description 41 and comprises further attributes and properties. Service description 43 inherits from service description 42.

All four service descriptions 41, . . . , 44 describe services located on different service provider hosts 14, 15.

Moreover, in this preferred embodiment, the client application 111 stored at service customer host 11 is compliant with a service which service description 41, 42 is located at a level of the hierarchical tree structure higher than the service description 43 the service customer host 11 whishes to use.

For example client application 1 11 is compliant with service description 41 and the service required by service customer host 11 is compliant to service description 43.

In this embodiment, client application computer code means 412, 413 are linked to the service descriptions at the different levels of the hierarchy.

All computer code means may be stored in a table, each service description pointing to the entry of the table containing the corresponding computer code means.

Computer code means 412, resp. 413 are dedicated to update client application 111 so that it becomes compliant to the service description 42, resp.43 having a lower level in the service description hierarchy than the service description 41 it is compliant to.

In the method according to the present embodiment, the steps 31 to 34 described in relation with FIG. 3 are executed the same way. In the example below, the service description 43 is found to fulfill the request sent by service customer 11 and an identifier of service provider host 14 has been returned to the communication module of service customer host 11 at step 34.

Additionally steps Al to A4 are executed after step 34.

Step A1 consists in downloading to service customer host 11 the computer code means 412, 413 necessary to update client application 111 so that it becomes compliant to service description 43. In a first embodiment, the whole computer code means may be directly downloaded from service description server to service customer host 11.

Alternatively, several delta updates portions may be successively necessary to perform the update. For example, a first update to upgrade client application 111 from service description 41 to service description 42 and a second update to upgrade service description 42 to service description 43.

Step A2 consists in presenting to the customer a Graphical User Interface taking into account the characteristics of the client application 111 and of the downloaded computer code means.

Step A3 consists in performing a usual client/server communication between client application upgraded by the computer code means and service provide host 14 supporting the service described by service description 43.

Step A4 consists upon termination of the client/server communication in deleting the computer code means from service customer host and return to the original client application 111. This step is optional but recommended to keep the size of the client application 111 as small as possible (i.e. only compatible with the root service description 41)

This embodiment enables to flexibly provide services which are not completely compliant with the chosen service description.

1/ Method for providing services in a communication network comprising service customer hosts and service provider hosts, said service customer hosts comprising a client application adopted to perform a client/server communication, wherein said method comprises the steps of:
Storing data structures, herein called service profiles, at a predefined communication network repository, a service profile comprising attributes and properties representing a service type;
Storing one or more instantiations of said service profile, herein called service description, on a predefined service description server, each service description describing a service belonging to one service type and comprising an identifier of a service provider host providing said service.
Downloading a service profile at a communication module of said service customer host;
Generating at said service customer host a request describing a service by using attributes and properties of said service profile and sending said request to said service description server;
Searching at said service description server service descriptions fulfilling said request and returning to said communication module an identifier of a service provider host providing a service fulfilling said request;
Forwarding to said client application said identifier of a service provider host over an interface between said communication module and said client application; and
Performing a client/server communication between said client application and said identified service provider host.

2/ Method according to claim 1, further comprising the step of returning to said communication module executable code means for automatically starting said client/server communication.

3/ Method according to claim 1, being used in on-purpose configuration networks.

4/ Method according to claim 1, wherein service profiles and service descriptions are organised in hierarchical tree structure with inheritance mechanisms.

5/ Method according to claim 4, wherein each service description refers to computer code means to update said client application, said client application being compatible with a service description at an higher level in said hierarchical tree structure, said method further comprising the steps of:
downloading said computer code means to said service customer host prior to performing said client/server communication;
generating a graphic user interface comprising the features of said client application and of said computer code means; and
deleting said computer code means from said service customer host upon termination of said client/server communication.

6/ Service customer host for use in a communication network also comprising service provider hosts, said service customer host comprising:
a client application adapted to perform a client/server communication to a service provider host;
a communication module for downloading a data structure, herein called service profile, from a predefined network communication repository;
means for composing a request thanks to attributes and properties of said service profile and sending said request to a predefined service description server;
an interface between said communication module and said client application for forwarding to said client application an identifier of a service provider host returned from said predefined description server.

7/ Service customer host according to claim 6, being a wireless terminal belonging to an on-purpose configuration network.
